(19) United States
(12) Patent Application Publication
(10) Pub. No.: US 2012/0163790 A1
(43) Pub. Date: Jun. 28, 2012

(54) Stereo-Image Photographing Apparatus

(75) Inventors: Hiroaki Shimazaki, Osaka (JP); Tatsuro Juri, Osaka (JP); Kenjiro Tsuda, Kyoto (JP); Takashi Masuno, Osaka (JP); Yuji Nagaishi, Osaka (JP)

(73) Assignee: PANASONIC CORPORATION, Osaka (JP)

(21) Appl. No.: 13/334,081

(22) Filed: Dec. 22, 2011

(30) Foreign Application Priority Data
Dec. 24, 2010 (JP) 2010-288837
Nov. 22, 2011 (JP) 2011-255160

(51) Int. Cl. G03B 35/10

(52) U.S. Cl. 396/326

(57) ABSTRACT

A stereo-image photographing apparatus enabling readily, short time-span realization of lens-barrel optical-axis adjustment in left- and right-eye imaging devices is afforded. The apparatus includes: a beam splitter having an incident surface of rectangular form, on which imaging light from a photographic subject is incident, an optically functional surface that reflects first imaging light, being a portion of incident imaging light, in a direction paralleling the shorter side of the rectangular form and that passes second imaging light being the remaining portion of the incident imaging light, a first light-exit surface through which the first imaging light exits, and a second light-exit surface through which the second imaging light exits; a first lens barrel directly facing the first light-exit surface; a second lens barrel directly facing the second light-exit surface; a first imaging device mounted on the first lens barrel; and a second imaging device mounted on the second lens barrel.

### CROSS REFERENCE TO RELATED APPLICATION

The disclosure of Japanese Patent Application Nos. 2010-288837, filed on Dec. 24, 2010, and 2011-255160, filed on Nov. 22, 2011, is incorporated herein by reference.

### BACKGROUND OF THE INVENTION

1. Field of the Invention

The present invention relates to stereo-image photographing apparatuses that, employing dual imaging devices, take stereoscopically visible images, and more particularly relates to a stereo-image photographing apparatus whereby precise adjustment of the optical axes of lens barrels mounted on the dual imaging devices is made.

2. Description of the Background Art

In a conventional stereo-image photographing apparatus, imaging light from a photographic subject is separated into imaging light for the left eye and imaging light for the right eye, and a left-eye imaging device that receives the left-eye imaging light and a right-eye imaging device that receives the right-eye imaging light are used to generate a stereoscopic image that causes a viewer to sense a stereoscopic effect.

FIG. 11 is a diagram illustrating a stereo-image photographing apparatus 900 in conventional art. In FIG. 11, the stereo-image photographing apparatus 900 includes a left-eye imaging device 910, a right-eye imaging device 920, and a semi-reflective mirror 930.

The semi-reflective mirror 930 reflects left-eye imaging light that is one portion of the imaging light from a photographic subject, and passes right-eye imaging light that is the remaining portion of the subject imaging light. The left-eye imaging device 910 generates an image for the left eye on the basis of image-constructing imaging light for the left eye, and the right-eye imaging device 920 generates an image for the right eye on the basis of image-constructing imaging light for the right eye. In this manner, the stereo-image photographing apparatus 900 in the conventional art generates, on the basis of the left-eye image and the right-eye image a stereoscopic image that causes a viewer to sense a stereoscopic effect.

Therein, in order to generate a stereoscopic image that gives a viewer an optimal stereoscopic impression, adjustment of the optical axis of the lens barrel in the left-eye imaging device and the optical axis of the lens barrel in the right-eye imaging device is crucial. Specifically, it is crucial to precisely adjust the optical axes of the lens barrels in the dual imaging devices such that the optical axes lie in the same horizontal plane. That is, adjusting the axes so that the image taken by the left-eye imaging device and the image taken by the right-eye imaging device have no discrepancies (vertical shift, trapezoidal distortion, or the like) other than the difference in imaging position horizontally makes it possible to obtain an image that does not hinder a viewer from recognizing the dual images as a stereo image. In addition, in order to control the intensity of the stereoscopic effect, adjustment of the interval (stereo base) between the construct-image positions along the optical axes of the dual lens barrels, and adjustment of the angle (angle of convergence) that the two optical axes form is crucial.

Japanese Patent No. 4293821 discloses technology relating to a stereo-image photographing apparatus, employing a semi-reflective mirror, that allows the stereo base to be freely set.

However, with the stereo-image photographing apparatus in the conventional art, readily realizing, in a short time-span, optical-axis adjustment whereby the angle between the semi-reflective mirror and the optical axis of the lens barrel in the left-eye imaging device and the angle between the semi-reflective mirror and the optical axis of the lens barrel in the right-eye imaging device are brought to precisely 45 degrees has been challenging.

### SUMMARY OF THE INVENTION

Therefore, it is an object of the present invention to make available a stereo-image photographing apparatus that makes it possible readily to realize, in a short time-span, optical-axis adjustment of the lens barrels in a left-eye imaging device and a right-eye imaging device.

In order to attain the object mentioned above, a stereo-image photographing apparatus of the present invention includes: a beam splitter having an incident surface of rectangular form and on which imaging light from a photographic subject is incident, an optically functional surface reflecting first imaging light, being a portion of imaging light incident on the incident surface, in a direction paralleling the shorter side of the rectangular form and passing second imaging light being the remaining portion of the imaging light, a first light-exit surface through which the first imaging light exits, and a second light-exit surface through which the second imaging light exits; a first lens barrel directly facing the first light-exit surface and through which the first imaging light exiting the first light-exit surface constructs an image; a second lens barrel directly facing the second light-exit surface and through which the second imaging light exiting the second light-exit surface constructs an image; a first imaging device mounted on the first lens barrel, for generating a first image on the basis of the first imaging light constructing an image through the first lens barrel; and a second imaging device mounted on the second lens barrel, for generating a second image on the basis of the second imaging light constructing an image through the second lens barrel.

According to this configuration, by causing the first lens barrel and the second lens barrel to directly face the first light-exit surface and the second light-exit surface, respectively, of the beam splitter, optical axis adjustment is allowed to readily be realized in a short time-span such that the angle between the optically functional surface within the beam splitter and the optical axis of the first lens barrel and the angle between the optically functional surface within the beam splitter and the optical axis of the second lens barrel are brought to precisely 45 degrees.

Preferably, the stereo-image photographing apparatus of the present invention further includes: a first lens-barrel holding member placing an end of the first lens barrel into abutment with the first light-exit surface such that the optical axis of the first lens barrel is retained perpendicular to the first light-exit surface; and a second lens-barrel holding member placing an end of the second lens barrel into abutment with the second light-exit surface such that the optical axis of the second lens barrel is retained perpendicular to the second light-exit surface.

According to this configuration, it is possible to more precisely fix the positional relationship between the beam splitter and the first and second lens barrels.

Moreover, preferably, the first lens barrel is a lens barrel to and from which the first lens barrel holding member is attachable and detachable; and the second lens barrel is a lens barrel to and from which the second lens barrel holding member is attachable and detachable.

According to this configuration, it is possible to separate the beam splitter and the first and second lens barrels from each other via the first lens barrel holding member and the second lens barrel holding member. As a result, it is possible to replace the first lens barrel and the second lens barrel according to need, and thus it is possible to select an appropriate lens barrel according to purposes of imaging.

Further, the preferable stereo-image photographing apparatus of the present invention further includes: a beam-splitter holding member retaining the beam splitter; a first imaging-device holding member retaining the first imaging device; a second imaging-device holding member retaining the second imaging device; and a base member retaining the beam-splitter holding member, the first imaging-device holding member, and the second imaging-device holding member. The first imaging-device holding member maintains a positional relationship, determined by the first lens-barrel holding member, between the first lens barrel and the beam splitter, and the second imaging-device holding member maintains a positional relationship, determined by the second lens-barrel holding member, between the second lens barrel and the beam splitter.

According to this configuration, the positional relationship among the beam splitter, the first imaging device, and the second imaging device is maintained by the base member. As a result, the positional relationship between the beam splitter and the first and second lens barrels can be maintained.

Moreover, preferably, the beam splitter holding member and the base member are integrally formed.

According to this configuration, the positional relationship among the beam splitter, the first imaging device, and the second imaging device can be maintained more stably.

Moreover, the preferable stereo-image photographing apparatus of the present invention further includes a beam splitter holding member which retains the beam splitter, and the beam splitter holding member, the first lens barrel holding member, and the second lens barrel holding member are secured to retain the beam splitter, the first imaging device, and the second imaging device.

According to this configuration, the first imaging device and the second imaging device which are small in size and light in weight can be mounted directly on the beam splitter. As a result, it is possible to realize a stereo-image photographing apparatus which is small in size and light in weigh as a whole.

Moreover, the preferable stereo-image photographing apparatus of the present invention further includes at least one of either a slider mounted on the first light-exit surface of the beam splitter to enable the first lens-barrel holding member to parallel-shift along the longer side of the rectangular form, or a slider mounted on the second light-exit surface of the beam splitter to enable the second lens-barrel holding member to parallel-shift along the longer side of the rectangular form.

According to this configuration, it is possible to change only a stereo base while the angle between the optically functional surface within the beam splitter and the optical axis of the first lens barrel and the angle between the optically functional surface within the beam splitter and the optical axis of the second lens barrel are maintained constant.

As described above, according to the stereo-image photographing apparatus of the present invention, the optical axes of the lens barrels in the left eye imaging device and the right eye imaging device are allowed to readily be adjusted in a short time-span.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating the configuration of a stereo-image photographing apparatus 100 according to a first embodiment of the present invention;

FIG. 2 is a schematic top view illustrating the configuration of the stereo-image photographing apparatus 100 shown in FIG. 1;

FIG. 3A is a diagram illustrating the positional relationship between photographic subjects and first and second imaging devices 111 and 121 shown in FIGS. 1 and 2;

FIG. 3B is a diagram illustrating an image for a left eye and an image for a right eye which are generated by the first and second imaging devices 111 and 121;

FIG. 4 is a diagram schematically illustrating an exemplary configuration of a lens barrel holding member which varies a stereo base in the stereo-image photographing apparatus 100 shown in FIGS. 1 and 2;

FIG. 5 is a diagram schematically illustrating a connection portion between a first lens barrel holding member 112 and a first lens barrel 110 and a connection portion between a second lens barrel holding member 122 and a second lens barrel 120 in the stereo-image photographing apparatus 100 shown in FIGS. 1 and 2;

FIG. 6 is a diagram schematically illustrating an exemplary configuration of a first imaging device holding member 113 and a second imaging device holding member 123 in the stereo-image photographing apparatus 100 shown in FIGS. 1 and 2;

FIG. 7 is a diagram schematically illustrating an exemplary configuration in which a beam splitter holding member 106 and a base member 107 are integrated to each other in the stereo-image photographing apparatus 100 shown in FIGS. 1 and 2;

FIG. 8 is a schematic diagram illustrating the configuration of a stereo-image photographing apparatus 500 according to a second embodiment of the present invention;

FIG. 9 is a diagram schematically illustrating an exemplary configuration of a lens barrel holding member which varies a stereo base in the stereo-image photographing apparatus 500 shown in FIG. 8;

FIG. 10 is a diagram schematically illustrating a connection portion between a first imaging device 501 and a first lens barrel holding member 601 in the stereo-image photographing apparatus 500 shown in FIG. 9;

FIG. 11 is a schematic diagram illustrating the configuration of a stereo-image photographing apparatus 700 according to a third embodiment of the present invention; and

FIG. 12 is a diagram illustrating a stereo-image photographing apparatus 900 in the conventional art.

### DESCRIPTION OF THE PREFERRED EMBODIMENTS

Hereinafter, each embodiment of the present invention will be described with reference to the drawings.

### First Embodiment

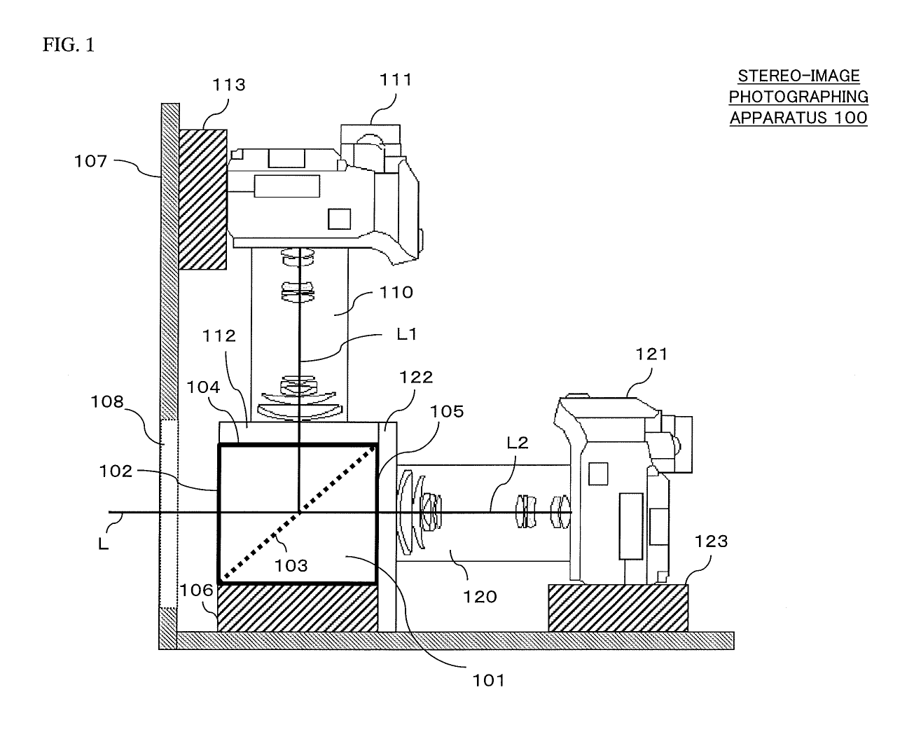

FIG. 1 is a schematic diagram illustrating the configuration of a stereo-image photographing apparatus 100 according to a first embodiment of the present invention. In FIG. 1, the stereo-image photographing apparatus 100 includes a beam splitter 101, a first lens barrel 110, a second lens barrel 120, a first imaging device 111, and a second imaging device 121.

The first imaging device 111 is a left eye imaging device which generates an image for a left eye, and the second imaging device 121 is a right eye imaging device which generates an image for a right eye.

The beam splitter 101 has an optically functional surface 103 which separates imaging light from a photographic subject, into first imaging light and second imaging light. The optically functional surface 103 has a property to reflect a portion of incident light and pass the remaining portion of the incident light. In use of the stereo-image photographing apparatus 100, it is preferred to cause the brightness of an image for a right eye to coincide with the brightness of an image for a left eye, and thus a semi-reflective mirror surface is used as the optically functional surface 103. The optically functional surface 103 is typically formed by depositing metal on an inclined surface of a triangular prism which constitutes the beam splitter 101, but may be formed of a film having the function of a semi-reflective mirror.

The imaging light

from the photographic subject is incident on an incident surface 102 of the beam splitter 101. The first imaging light reflected by the optically functional surface 103 is incident on the first lens barrel 110. The first imaging light incident on the first lens barrel 110 constructs an image on an imaging surface of a solid-state image sensor or the like within the first imaging device 111, and is photoelectrically converted into an image signal for a left eye. In this manner, the first imaging device 111 generates an image for a left eye.

The second imaging light having passed through the optically functional surface 103 is incident on the second lens barrel 120. The second imaging light incident on the second lens barrel 120 constructs an image on an imaging surface of a solid-state image sensor or the like within the second imaging device 121, and is photoelectrically converted into an image signal for a right eye. In this manner, the second imaging device 121 generates an image for a right eye.

Here, when shift other than a parallax, such as vertical shift or shift caused by a trapezoidal distortion, occurs between a photographic subject image on the image for a left eye and a photographic subject image on the image for a right eye, a viewer cannot observe the two photographic subject images as a stereoscopic image by means of fusion, or can observe the two photographic subject images as a stereoscopic image but feels eye fatigue. In addition, when the amount of a parallax is excessively great, the viewer cannot obtain a preferable stereoscopic effect when observing a stereoscopic image. Thus, it is crucial to precisely adjust the inclination of the optical axis L1 of the first lens barrel 110 and the inclination of the optical axis L2 of the second lens barrel 120. In other words, an optical axis obtained by bending the optical axis L1 of the first lens barrel 110 by the optically functional surface 103 and an optical axis obtained by causing the optical axis L2 of the second lens barrel 120 to pass through the optically functional surface 103 have to coincide with each other to be an optical axis L as shown in FIG. 1, when seen from the lateral direction of the stereo-image photographing apparatus 100.

In the stereo-image photographing apparatus 100 according to the first embodiment of the present invention, the beam splitter 101 has a rectangular parallelepiped shape, and the cross section of the beam splitter 101 has a square shape as shown in FIG. 1, when seen from the lateral direction of the stereo-image photographing apparatus 100.

A second light-exit surface 105 of the beam splitter 101 is formed so as to be precisely parallel to the incident surface 102. In addition, a first light-exit surface 104 of the beam splitter 101 is formed so as to be precisely perpendicular to both the incident surface 102 and the second light-exit surface 105. Moreover, the optically functional surface 103 provided within the beam splitter 101 is formed so as to precisely make an angle of 45 degrees with each of the incident surface 102, the first light-exit surface 104, and the second light-exit surface 105. The incident surface 102, the optically functional surface 103, the first light-exit surface 104, and the second light-exit surface 105 are formed as flat surfaces with very high accuracy by polishing or the like.

As described above, the flatness and angle of each surface of the beam splitter 101 are very highly precise. Thus, when the first lens barrel 110 is caused to directly face the first light-exit surface 104 and the second lens barrel 120 is caused to directly face the second light-exit surface 105, the optical axis obtained by bending the optical axis L1 of the first lens barrel 110 by the optically functional surface 103 and the optical axis obtained by causing the optical axis L2 of the second lens barrel 120 to pass through the optically functional surface 103 can be caused to coincide with each other to be the optical axis L as shown in FIG. 1, when seen from the lateral direction of the stereo-image photographing apparatus 100. It should be noted that causing a lens barrel to directly face a light-exit surface means to locate the lens barrel in front of the light-exit surface such that the interval between the outer circumference of a lens included in the lens barrel and the light-exit surface is uniformed. In a state where the lens barrel is caused to directly face the light-exit surface, the optical axis of the lens barrel is perpendicular to the light-exit surface.

As described above, according to the stereo-image photographing apparatus 100 according to the first embodiment of the present invention, since the beam splitter 101 is precisely formed, by causing the first lens barrel 110 and the second lens barrel 120 to directly face the first light-exit surface 104 and the second light-exit surface 105, respectively, of the beam splitter 101, optical axis adjustment is allowed to readily be realized in a short time-span such that the angle between the optically functional surface 103 within the beam splitter 101 and the optical axis L1 of the first lens barrel 110 and the angle between the optically functional surface 103 within the beam splitter 101 and the optical axis L2 of the second lens barrel 120 are brought to precisely 45 degrees.

It should be noted that as shown in FIG. 1, the stereo-image photographing apparatus 100 may include a first lens barrel holding member 112 which retains the first lens barrel 110 such that an end of the first lens barrel 110 is in contact with the first light-exit surface 104. The first lens barrel holding member 112 precisely fixes the beam splitter 101 and the first lens barrel 110 such that the first light-exit surface 104 and the optical axis L1 of the first lens barrel 110 are perpendicular to each other.

Similarly, the stereo-image photographing apparatus 100 may include a second lens barrel holding member 122 which retains the second lens barrel 120 such that an end of the second lens barrel 120 is in contact with the second light-exit surface 105. The second lens barrel holding member 122 precisely fixes the beam splitter 101 and the second lens barrel 120 such that the second light-exit surface 105 and the optical axis L2 of the second lens barrel 120 are perpendicular to each other.

Further, as shown in FIG. 1, the stereo-image photographing apparatus 100 may include a beam splitter holding member 106, a first imaging device holding member 113, a second imaging device holding member 123, and a base member 107. The beam splitter holding member 106 retains the beam splitter 101, the first imaging device holding member 113 retains the first imaging device 111, and the second imaging device holding member 123 retains the second imaging device 121. The base member 107 retains the beam splitter holding member 106, the first imaging device holding member 113, and the second imaging device holding member 123 to fix a mutual positional relationship thereamong. As a result, the positional relationship between the beam splitter 101 and the first and second lens barrels 110 and 120 can be maintained. It should be noted that a front window 108 is provided in the base member 107 such that imaging light can be incident on the incident surface 102 of the beam splitter 101 therethrough.

Moreover, in order for the viewer to obtain a preferable stereoscopic effect when observing a stereoscopic image, the interval (stereo base) between the construct-image position along the optical axis L1 of the first lens barrel 110 and the construct-image position along the optical axis L2 of the second lens barrel 120 and the angle (angle of convergence) that the optical axis L1 of the first lens barrel 110 and the optical axis L2 of the second lens barrel 120 form have to appropriately be set.

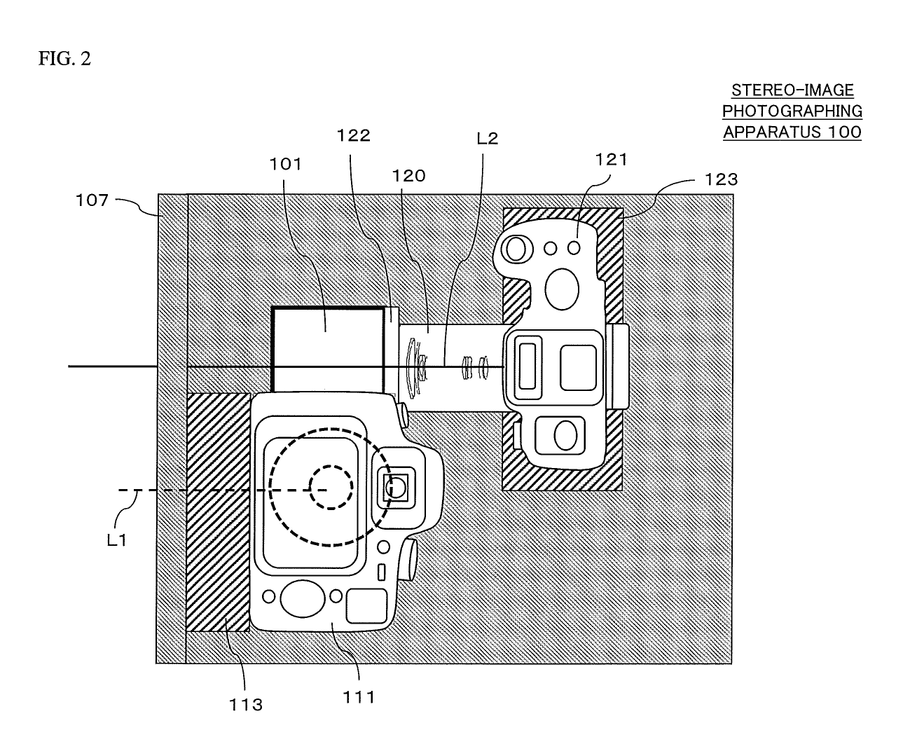

FIG. 2 is a schematic top view illustrating the configuration of the stereo-image photographing apparatus 100, shown in FIG. 1, according to the first embodiment of the present invention. In FIG. 2, the optical axis obtained by bending the optical axis L1 of the first lens barrel 110 by the optically functional surface 103 and the optical axis obtained by causing the optical axis L2 of the second lens barrel 120 to pass through the optically functional surface 103 have to be adjusted to have an appropriate inter-axis distance and angle of convergence when seen from the top surface of the stereo-image photographing apparatus 100.

Here, the stereo base and the angle of convergence will be described in detail. It should be noted that for simplification of explanation, a description will be given on the assumption that in the stereo-image photographing apparatus 100 shown in FIGS. 1 and 2, the beam splitter 101 having the optically functional surface 103 is omitted and the first imaging device 111 and the second imaging device 121 are present on the same plane.

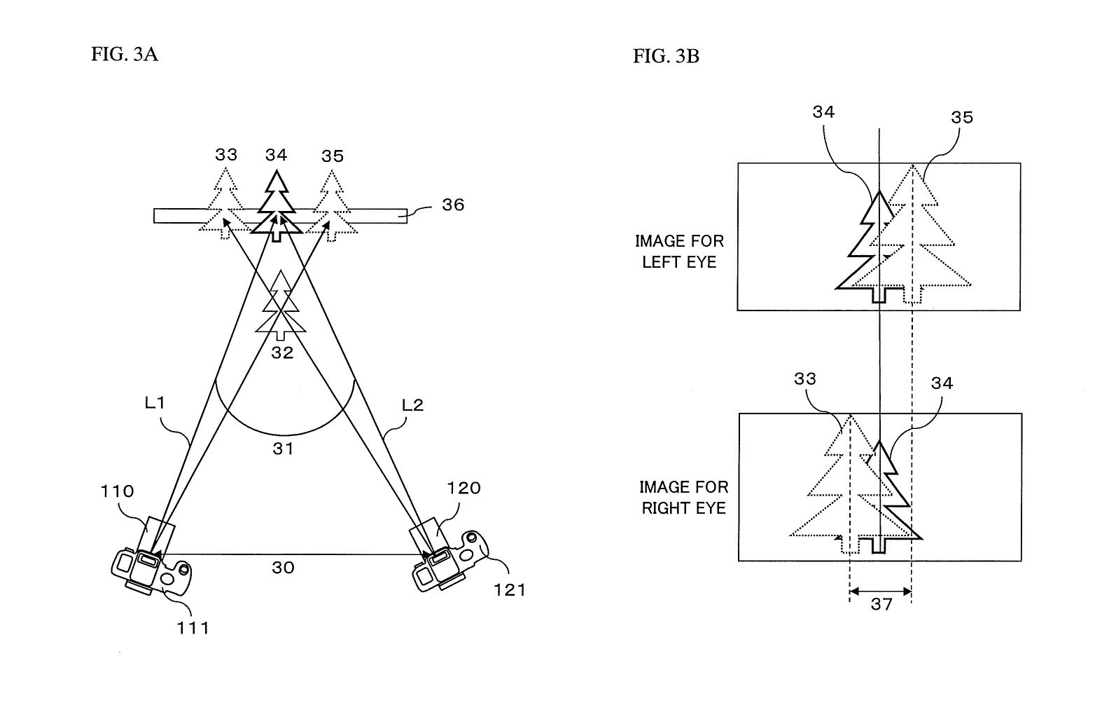

FIG. 3A is a diagram illustrating the positional relationship among the first imaging device 111, the first lens barrel 110, the optical axis L1, the second imaging device 121, the second lens barrel 120, the optical axis L2, and photographic subjects. FIG. 3A is a diagram illustrating an image for a left eye and an image for a right eye which are generated by the first imaging device 111 and the second imaging device 121.

In FIG. 3A, images of a photographic subject 34 present at a point at which the optical axis L1 of the first lens barrel 110 intersects with the optical axis L2 of the second lens barrel 120 are taken at the same lateral position as shown in FIG. 3B as an image for a left eye and an image for a right eye. It should be noted that since the optical axes L1 and L2 of the lens barrels in the two imaging devices precisely lie in the same horizontal plane, the image for a left eye taken by the first imaging device 111 and the image for a right eye taken by the second imaging device 121 have no discrepancies (vertical shift, trapezoidal distortion, or the like) other than the difference in imaging position horizontally.

Meanwhile, images of the photographic subject 32 present on the near side of the point at which the optical axis L1 of the first lens barrel 110 intersects with the optical axis L2 of the second lens barrel 120 are taken as photographic subject images projected on a virtual screen 36 which is assumed at the same camera distance as that of the photographic subject 34. In other words, an image of the photographic subject 32 is taken by the first imaging device 111 corresponding to the viewpoint of a left eye, as a photographic subject image 35 projected on the virtual screen 36. Similarly, an image of the photographic subject 32 is taken by the second imaging device 121 corresponding to the viewpoint of a right eye, as a photographic subject image 33 projected on the virtual screen 36.

Therefore, photographic subject images of the photographic subject 32 are taken at positions distant from each other by a parallax amount 37, as shown in FIG. 3B, in the stereo-image photographing apparatus 100 including the first imaging device 111 and the second imaging device 121.

Here, as the parallax increases (the interval between the photographic subject image 33 and the photographic subject image 35 increases), the stereoscopically displayed photographic subject image is seen as if projecting toward the near side of the virtual screen 36. Meanwhile, in FIG. 3A, when the positional relationship between the photographic subject image 33 and the photographic subject image 35 is reversed such that the photographic subject image 33 is located on the right eye side of the photographic subject image 35 and the photographic subject image 35 is located on the left eye side of the photographic subject image 33, the stereoscopically displayed photographic subject image is seen as if being recessed toward the far side of the virtual screen 36.

When the parallax between the image for a left eye and the image for a right eye is excessively great (the photographic subject image excessively projects), eye fatigue of the viewer is caused. This is because the depth distance between the position of the photographic subject 32 and the virtual screen 36 on which the eyes actually focus is excessively large. In addition, when a range of a parallax of each photographic subject is excessively large in the same screen, namely, when the distance between a projecting photographic subject image and a recessed photographic subject image is excessively large, the viewer feels eye fatigue. Further, when the amount of a parallax rapidly changes with time, the eyes of the viewer cannot follow the change, and thus eye fatigue is caused.

In order to take an appropriate stereoscopic display image such that the viewer obtains a stereoscopic effect from a displayed image while such causes of eye fatigue of the viewer are taken into consideration, the interval (stereo base) 30 between the construct-image position along the optical axis L1 of the first lens barrel 110 and the construct-image position along the optical axis L2 of the second lens barrel 120 and the angle of convergence 31 between the optical axis L1 of the first lens barrel 110 and the optical axis L2 of the second lens barrel 120 have to be set to appropriate values by comparing to a position distribution of the photographic subject.

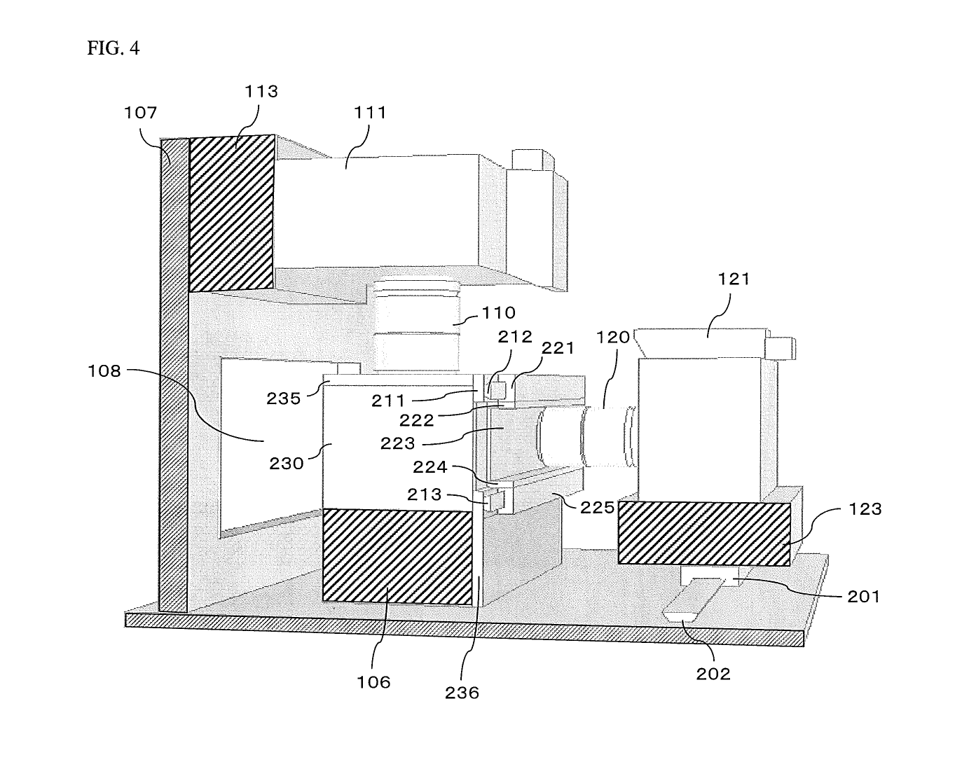

FIG. 4 is a diagram schematically illustrating an exemplary configuration of a lens barrel holding member which varies the stereo base in the stereo-image photographing apparatus 100, shown in FIGS. 1 and 2, according to the first embodiment of the present invention. In FIG. 4, the components described with reference to FIGS. 1 and 2 are designated by the same reference characters, and thus the detailed description thereof is omitted.

The stereo-image photographing apparatus shown in FIG. 4 differs from the stereo-image photographing apparatus 100 shown in FIGS. 1 and 2 in further including a slider which enables the second lens barrel 120 and the second imaging device 121 to parallel-shift along the second light-exit surface 105 of the beam splitter 101. The slider refers to a mechanism which rectilinearly shiftably guides a moved member, namely, a lens barrel and/or an imaging device along a specified direction and which restricts the lens barrel and/or the imaging device against shifting along another direction (a direction perpendicular to the specified direction). In the example of FIG. 4, the slider is realized by being composed of a second imaging device slider portion 201, a second imaging device rail portion 202, second lens barrel holding rail portions 211 to 213, and second lens barrel holding slider portions 221 to 225. It should be noted that the beam splitter 101 shown in FIGS. 1 and 2 is covered with a beam splitter holding member side portion 230, a beam splitter holding member upper portion 235, and a beam splitter holding member back portion 236 in FIG. 4.

The beam splitter 101 (not shown in FIG. 4) is installed on the beam splitter holding member 106, and fixed by being covered with the beam splitter holding member side portion 230, the beam splitter holding member upper portion 235, and the beam splitter holding member back portion 236. The second lens barrel holding rail portions 211 to 213 are mounted on the second light-exit surface 105 (not shown in FIG. 4) of the beam splitter 101.

To the second lens barrel holding rail portion 212, the second lens barrel holding slider portion 221 is provided so as to slide along the second light-exit surface 105 of the beam splitter 101 in the lateral direction (in the direction to the far side of the sheet plane and in the direction to the near side of the sheet plane). To the second lens barrel holding rail portion 213, the second lens barrel holding slider portion 225 is provided so as to slide along the second light-exit surface 105 of the beam splitter 101 in the lateral direction (in the direction to the far side of the sheet plane and in the direction to the near side of the sheet plane.

The second lens barrel holding slider portions 221 to 225 slide together on the second lens barrel holding rail portions 212 and 213 in the lateral direction in parallel to the second light-exit surface 105 of the beam splitter 101. Thus, the second lens barrel 120 mounted on the second lens barrel holding rail portions 212 and 213 moves in the lateral direction while maintaining the angle with the second light-exit surface 105 of the beam splitter 101. By so doing, it is possible to change only the stereo base while the optical axis direction is maintained constant.

Further, the second imaging device rail portion 202 is secured to the base member 107, and the second imaging device slider portion 201 is provided so as to slide on the second imaging device rail portion 202 in the lateral direction (in the direction to the far side of the sheet plane and in the direction to the near side of the sheet plane). When the weight of the second imaging device 121 is high, the second imaging device slider portion 201 and the second imaging device rail portion 202 may be configured such that the second imaging device rail portion 202 is movable in the lateral direction while the second imaging device slider portion 201 and the second imaging device rail portion 202 support the second imaging device 121. By so doing, a portion where the second lens barrel 120 and the second lens barrel holding slider portion 223 are joined to each other can be prevented from being distorted or broken due to the weight.

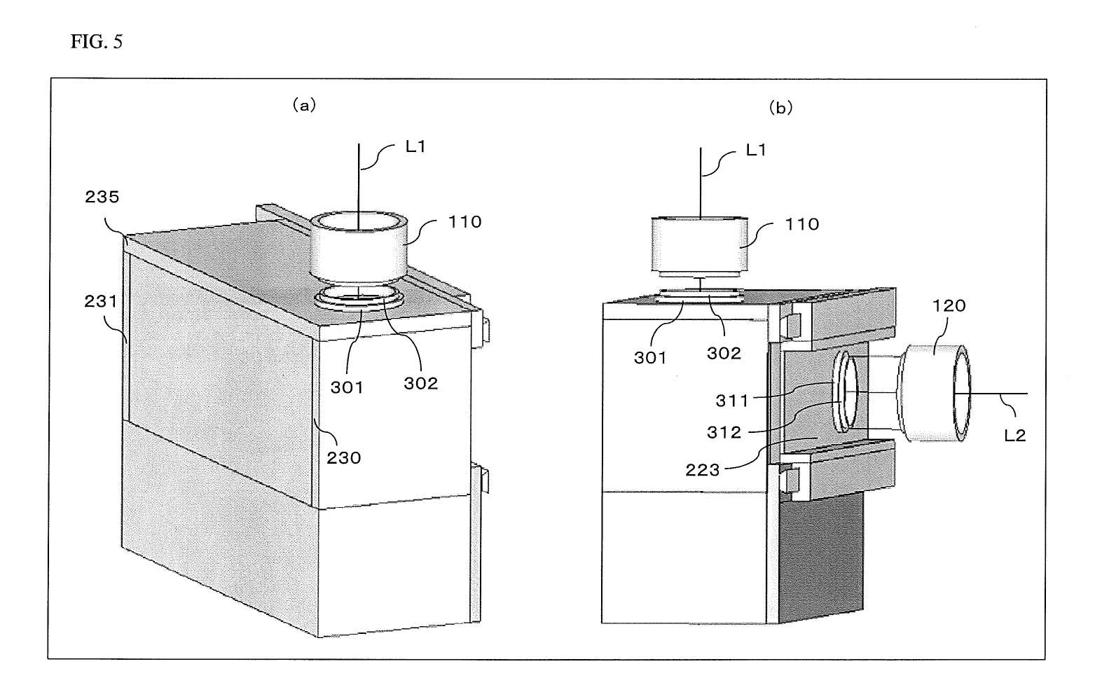

FIG. 5 is a diagram schematically illustrating a connection portion between the first lens barrel holding member 112 and the first lens barrel 110 and a connection portion between the second lens barrel holding member 122 and the second lens barrel 120 in the stereo-image photographing apparatus 100 shown in FIGS. 1 and 2. In FIG. 5, the first lens barrel 110 is fixed to the beam splitter holding member upper portion 235 by a first lens barrel holding ring 301 and a first lens barrel holding screw portion 302, and the second lens barrel 120 is fixed to the second lens barrel holding slider portion 223 by a second lens barrel holding ring 311 and a second lens barrel holding screw portion 312.

As shown in FIG. 5(a), the beam splitter 101 (not shown in FIG. 5) is fixed by being covered with the beam splitter holding member at its periphery except its front surface (the incident surface 102 shown in FIG. 1). The first lens barrel holding ring 301 is attached to the beam splitter holding member upper portion 235 of the beam splitter holding member by means of bonding, integral molding, or the like. The first lens barrel holding ring 301 is positioned in place on the base of the first light-exit surface 104 of the beam splitter 101. The first lens barrel holding screw portion 302 for connecting to the first lens barrel 110 is provided on the first lens barrel holding ring 301. The thread of the first lens barrel holding screw portion 302 is engaged with a thread portion provided on the inner surface of the first lens barrel 110, whereby the first lens barrel 110 can be fixed so as to be precisely perpendicular to the first light-exit surface 104 of the beam splitter 101.

Further, as shown in FIG. 5(b), the second lens barrel holding ring 311 is attached to the second lens barrel holding slider portion 223 by means of bonding, integral molding, or the like. The second lens barrel holding ring 311 is also positioned in place on the basis of the second light-exit surface 105 of the beam splitter 101. The second lens barrel holding screw portion 312 for connecting to the second lens barrel 120 is provided on the second lens barrel holding ring 311. The thread of the second lens barrel holding screw portion 312 is engaged with a thread portion provided on the inner surface of the second lens barrel 120, whereby the second lens barrel 120 can be fixed so as to be precisely perpendicular to the second light-exit surface 105 of the beam splitter 101.

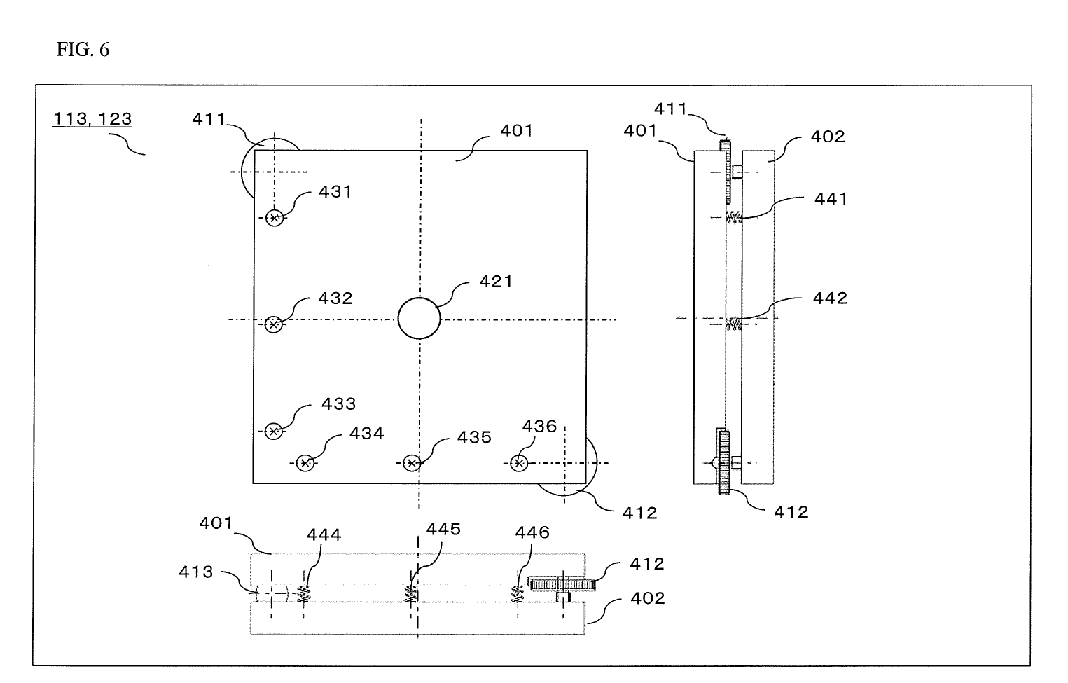

FIG. 6 is a diagram schematically illustrating an exemplary configuration of the first imaging device holding member 113 and the second imaging device holding member 123 in the stereo-image photographing apparatus 100 shown in FIGS. 1 and 2. In FIG. 6, the first imaging device holding member 113 and the second imaging device holding member 123 retain the first imaging device 111 and the second imaging device 121 by using a top plate 401, a bottom plate 402, windage screws 411 and 412, a ball 413, an imaging device fixing hole 421, spring fixing holes 431 to 436, and springs 441 to 446.

The top plate 401 and the bottom plate 402 are attracted to each other by the springs 441 to 446. The ball 413 and the windage screws 411 and 412 are located between the top plate 401 and the bottom plate 402 and maintain the interval between the top plate 401 and the bottom plate 402. By so doing, the top plate 401 and the bottom plate 402 are fixed.

The inclination of the top plate 401 with respect to the bottom plate 402 is adjustable by the two windage screws 411 and 412. The first imaging device 111 and the second imaging device 121 are fixed by a screw which is screwed into a threaded hole in the bottom surface of the main body through the imaging device fixing hole 421 of the top plate 401.

The positions and inclinations of the image sensors included in the first imaging device 111 and the second imaging device 121 can be adjusted by using the adjustment mechanisms of the first imaging device holding member 113 and the second imaging device holding member 123 shown in FIG. 6. However, when the connection portion between the first lens barrel holding member 112 and the first lens barrel 110 and the connection portion between the second lens barrel holding member 122 and the second lens barrel 120 have sufficient strength, for example, the ball 413 and the windage screws 411 and 412 may be omitted, and expansion and compression of the springs 441 to 446 may be adjusted only by strengths from the first lens barrel holding member 112 and the second lens barrel holding member 122 to the first imaging device 111 and the second imaging device 121, whereby it is configured to support the weights of the first imaging device 111 and the second imaging device 121. Further, when higher accuracy is required, the number of axes to be adjusted may be increased by using a rack-and-pinion mechanism or the like.

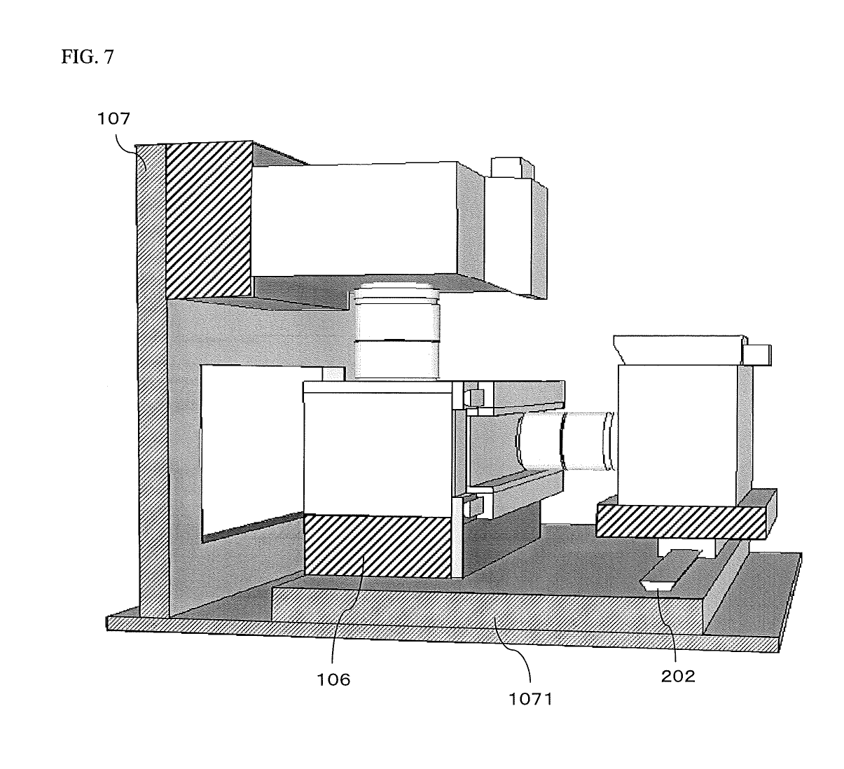

FIG. 7 is a diagram schematically illustrating an exemplary configuration in which the beam splitter holding member 106 and the base member 107 are integrated to each other in the stereo-image photographing apparatus 100 shown in FIGS. 1 and 2. As shown in FIG. 7, an additional base member 1071 is further provided on the base member 107, and the beam splitter holding member 106 and the second imaging device rail portion 202 on which the second imaging device holding member 123 is put are produced by integral molding. By so doing, the positional relationship between the beam splitter 101 and the second imaging device 121 can be maintained with higher accuracy.

### Second Embodiment

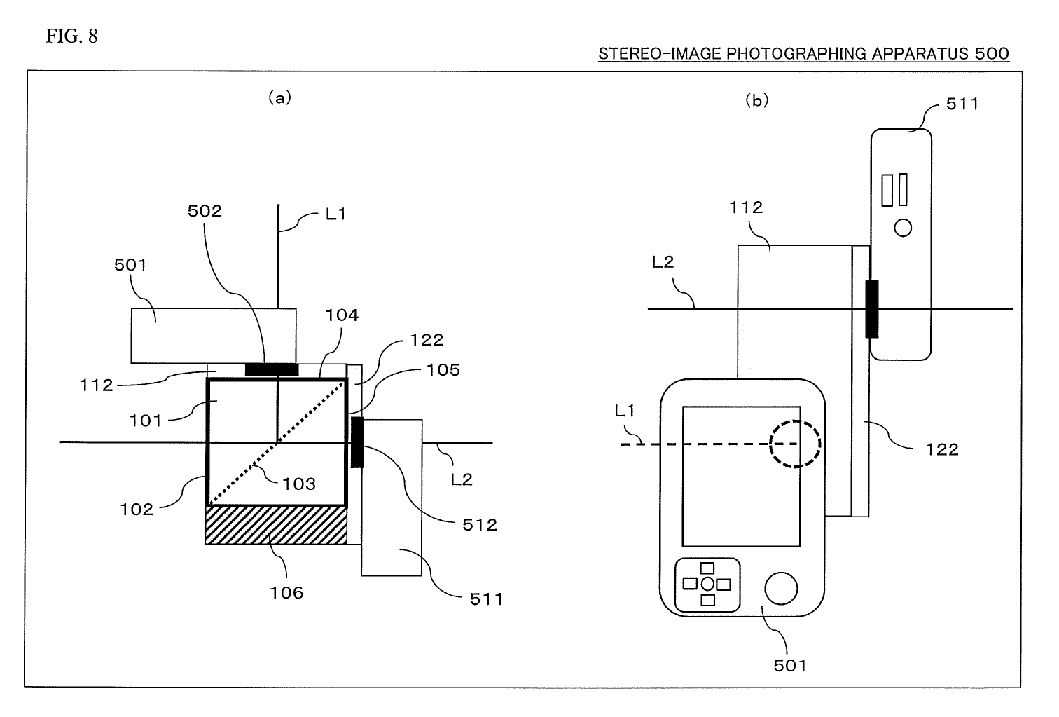

FIG. 8 is a schematic diagram illustrating the configuration of a stereo-image photographing apparatus 500 according to a second embodiment of the present invention. FIG. 8(a) is a side view of the stereo-image photographing apparatus 500, and FIG. 8(b) is a top view of the stereo-image photographing apparatus 500. In FIG. 8, the components described with reference to FIGS. 1 and 2 are designated by the same reference characters, and thus the detailed description thereof is omitted.

As imaging devices, a first imaging device 501 and second imaging device 511 which are small in size and light in weight are used. It should be noted that the first imaging device 501 and the second imaging device 511 includes a first lens barrel 502 and a second lens barrel 512, respectively.

The first lens barrel 502 and the second lens barrel 512 are held by the first lens barrel holding member 112 and the second lens barrel holding member 122, whereby the first imaging device 501 and the second imaging device 511 are supported. The configuration of the present embodiment is effective when the first imaging device 501 and the second imaging device 511 are light in weight to such a degree that the first imaging device 501 and the second imaging device 511 can be held only by the first lens barrel holding member 112 and the second lens barrel holding member 122.

As described above, according to the stereo-image photographing apparatus 500 according to the second embodiment of the present invention, when the first imaging device 501 and the second imaging device 511 are small in size and light in weight, each holding member needed in the stereo-image photographing apparatus 100 according to the first embodiment of the present invention is not needed, and thus the stereo-image photographing apparatus 500 can be decreased in size and weight as a whole.

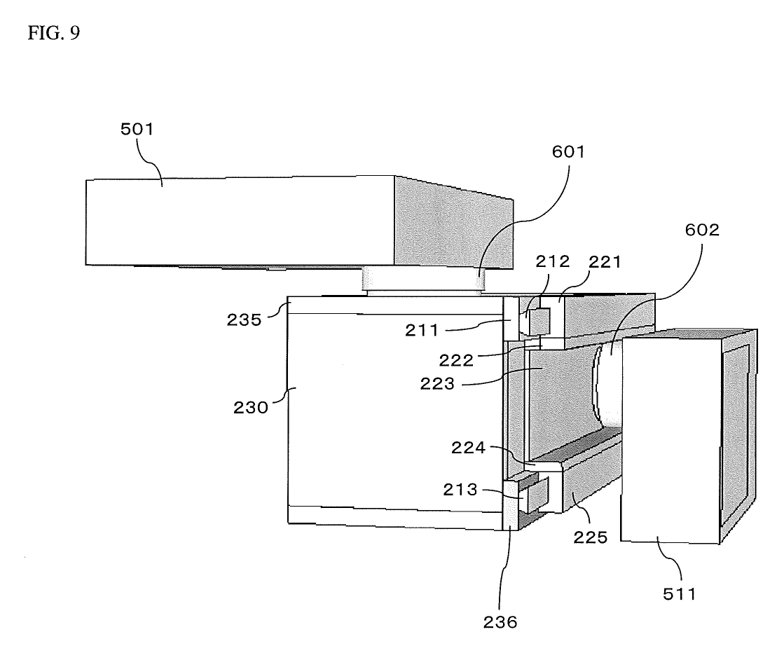

FIG. 9 is a diagram schematically illustrating an exemplary configuration of a lens barrel holding member which varies the stereo base in the stereo-image photographing apparatus 500, shown in FIG. 8, according to the second embodiment of the present invention. The stereo-image photographing apparatus shown in FIG. 9 differs from the stereo-image photographing apparatus 500 shown in FIG. 8 in further including a slider which enables the second lens barrel 512 and the second imaging device 511 to parallel-shift along the second light-exit surface 105 of the beam splitter 101. The slider shown in FIG. 9 is the same as that described with reference to FIG. 4 in the first embodiment of the present invention, and thus the same reference characters are used therefor and the detailed description thereof is omitted.

In FIG. 9, the first imaging device 501 is held only by a first lens barrel holding member 601. In addition, the second imaging device 511 is held only by a second lens barrel holding member 602. The second imaging device 511 is set by the second lens barrel holding rail portions 211 to 213 and the second lens barrel holding slider portions 221 to 225 such that the optical axis thereof is perpendicular to the second light-exit surface 105 of the beam splitter 101, and is movable in the lateral direction while maintaining the angle with the second light-exit surface 105 of the beam splitter 101.

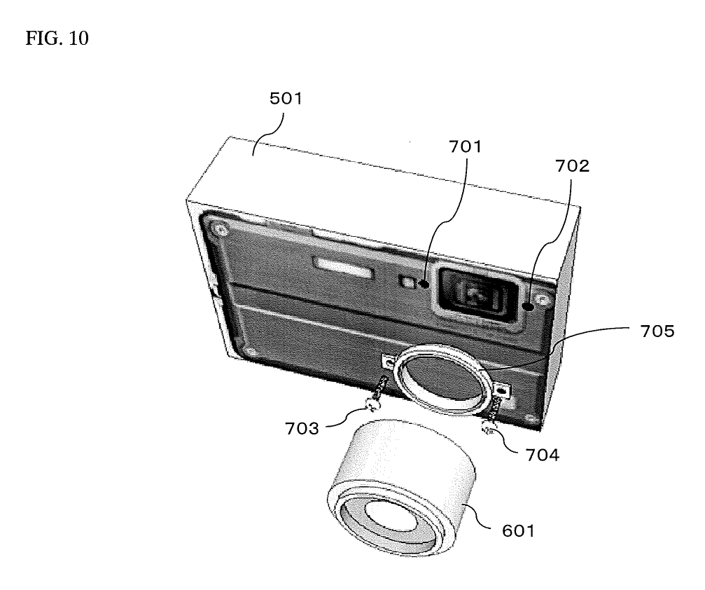

FIG. 10 is a diagram schematically illustrating a connection portion between the first imaging device 501 and the first lens barrel holding member 601 in the stereo-image photographing apparatus 500 shown in FIG. 8. Needless to say, a connection portion between the second imaging device 511 and the second lens barrel holding member 602 is the same as the connection portion between the first imaging device 501 and the first lens barrel holding member 601.

As shown in FIG. 10, a lens barrel holding member fixing base 705 is fixed to the first imaging device 501 by screws 703 and 704 being screwed into threaded holes 701 and 702. The first imaging device 501 is mounted on the first lens barrel holding member 601 via the lens barrel holding member fixing base 705.

Specifically, the lens barrel holding member fixing base 705 has the same configuration as those of the first lens barrel holding ring 301 and the first lens barrel holding screw portion 302 shown in FIG. 5. Thus, the first lens barrel holding member 601 can be attached to the first imaging device 501 by screwing a thread portion provided on its inner surface onto a thread portion provided on the outer surface of the lens barrel holding member fixing base 705. The configuration of the beam splitter side portion of the first lens barrel holding member 601 is the same as the configuration described with reference to FIG. 5. The first imaging device 501 can be mounted such that the optical axis thereof is perpendicular to the light-exit surface of the beam splitter.

It should be noted that the first lens barrel holding member 601 is not formed in a shape of a complete cylinder but formed such that the beam splitter side or the first imaging device 501 side is inclined, whereby the first lens barrel holding member 601 can be fixed while the angle between the optical axis and the light-exit surface of the beam splitter is maintained constant.

As described above, according to the stereo-image photographing apparatus 500 according to the second embodiment of the present invention, since the beam splitter 101 is precisely formed, by causing the first lens barrel 502 and the second lens barrel 512 to directly face the first light-exit surface 104 and the second light-exit surface 105, respectively, of the beam splitter 101, optical axis adjustment is allowed to readily be realized in a short time-span such that the angle between the optically functional surface 103 within the beam splitter 101 and the optical axis L1 of the first lens barrel 502 and the angle between the optically functional surface 103 within the beam splitter 101 and the optical axis L2 of the second lens barrel 512 are brought to precisely 45 degrees.

In the present embodiment, the first imaging device 501 and the second imaging device 511 are illustrated as compact digital cameras in FIGS. 8 to 10. However, the first imaging device 501 and the second imaging device 511 may also be configured as smaller and more lightweight imaging devices such as mobile phones equipped with cameras.

In the first and second embodiments of the present invention, the beam splitter, the first lens barrel, and the second lens barrel are precisely fixed such that the end of the first lens barrel is in contact with the first light-exit surface of the beam splitter, the end of the second lens barrel is in contact with the second light-exit surface of the beam splitter, the optical axis of the first lens barrel is retained perpendicular to the first light-exit surface, and the optical axis of the second lens barrel is retained perpendicular to the second light-exit surface. Here, in particular, as shown in FIGS. 1 and 2, each of the first lens barrel and the second lens barrel includes a plurality of lens units. As described above, the positional relationship among the beam splitter, the first lens barrel, and the second lens barrel is precisely set and fixed. Thus, even when the positions of lenses in the plurality of lens units are changed to adjust the focal length or focus, only the view angle or focus position can be changed without changing the precisely set positional relationship among the beam splitter, the first lens barrel, and the second lens barrel. In other words, the optical axis of the first lens barrel is retained perpendicular to the first light-exit surface, and the optical axis of the second lens barrel is retained perpendicular to the second light-exit surface.

Further, in the first and second embodiments of the present invention, the first imaging device and the second imaging device are individually useable as independent imaging devices, but the present invention is not limited thereto. For example, an exterior part may not be mounted on each imaging device, each imaging device may be mounted as a dedicated mechanism on the stereo-image photographing apparatus, and the entire stereo-image photographing apparatus including each holding member such as a base member may be covered with another exterior part. In such a case, each imaging device does not have to be equipped with a finder and a liquid crystal display.

### Third Embodiment

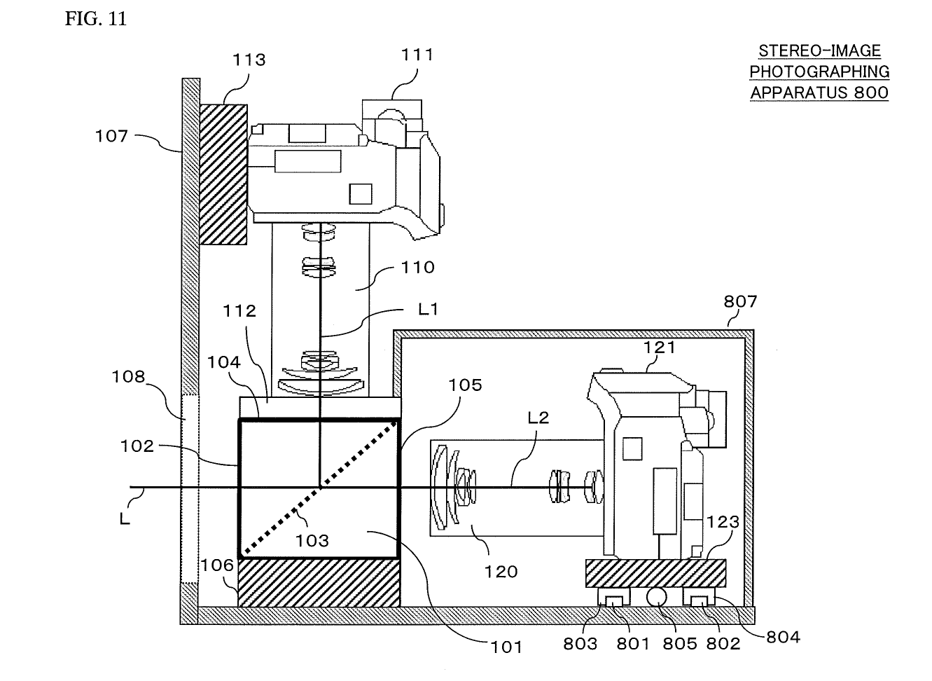

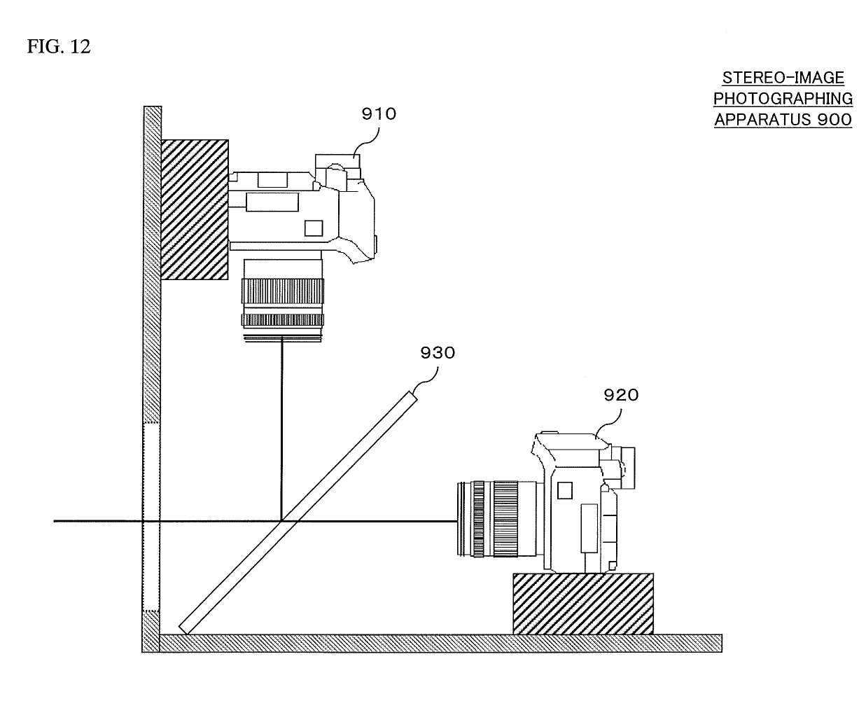

FIG. 11 is a schematic diagram illustrating the configuration of a stereo-image photographing apparatus 800 according to a third embodiment of the present invention. The stereo-image photographing apparatus 800 according to the present embodiment differs from the stereo-image photographing apparatuses according to the first and second embodiments in a method for arranging the second lens barrel 120 and the second imaging device 121 which are used for taking an image for a right eye. Hereinafter, the difference between the present embodiment and each embodiment described above will mainly be described.

The second lens barrel 120 mounted on the second imaging device 121 is located so as to directly face the second light-exit surface 105 of the beam splitter 101 similarly to each embodiment described above. However, the second lens barrel 120 is not in contact with the second light-exit surface 105 and is spaced apart from the second light-exit surface 105 at a predetermined interval. Similarly to the configuration in FIG. 4, the second imaging device 121 is mounted to the second imaging device holding member 123 by means of a threaded hole for fitting a tripod, or the like.

The second imaging device holding member 123 is supported by a slider mechanism so as to be horizontally movable. Specifically, second imaging device slider portions 803 and 804 are fixed to the lower surface of the second imaging device holding member 123. The second imaging device slider portions 803 and 804 are slidably engaged with second imaging device rail portions 801 and 802 fixed on the base member 107. The second imaging device rail portions 801 and 802 are positioned in place on the basis of the second light-exit surface 105 of the beam splitter 101, and are parallel to both the plane including the first light-exit surface 104 and the plane including the second light-exit surface 105. Further, in order to move the second imaging device holding member 123 along the second imaging device rail portions 801 and 802, a feed mechanism 805 is provided. The feed mechanism 805 is composed of, for example, a combination of a feed screw or a ball screw and a motor. Moreover, in the present embodiment, instead of providing a light-blocking member on the second light-exit surface 105, a light-blocking cover 807 is provided so as to cover at least the second light-exit surface 105, the second lens barrel 120, the second imaging device 121, and the second imaging device holding member 123.

According to the stereo-image photographing apparatus 800 according to the present embodiment, since the slide direction of the slider mechanism is set on the basis of the second light-exit surface 105 of the beam splitter 101, the second lens barrel 120 and the second imaging device 121 can be moved in parallel with high accuracy while the inclination of the optical axis of the second lens barrel 120 with respect to the second light-exit surface 105 is maintained. Further, in the present embodiment, any other member does not have to be in contact with the second light-exit surface 105, and thus damage of the second light-exit surface 105 of the beam splitter 101 is prevented. Moreover, the optical path can be changed on the basis of the interval between the second light-exit surface 105 and the second lens barrel 120, and thus the configuration of the present embodiment is effective particularly when it is desired to insert an optical element such as a prism between the beam splitter 101 and the first lens barrel 110.

As the slider mechanism described in each embodiment described above, the following various variations are considered.

For example, in the configuration shown in FIG. 4, the slider mechanism including the rail and the slider is provided on both the second light-exit surface 105 of the beam splitter 101 and the second imaging device holding member 123, but the slider mechanism may not be provided on the second light-exit surface 105, and the second lens barrel 120 may merely be slid in contact with the second light-exit surface 105. In such a case, a light-blocking cover is provided so as to cover at least the second light-exit surface, the second lens barrel 120, and the second imaging device 121.

Further, in the configurations shown in FIGS. 4 and 9, the slider mechanism which slides along the second light-exit surface 105 of the beam splitter 101 is provided. However, the slider mechanism can also be configured to slide along the first light-exit surface 104 in the longitudinal direction of the beam splitter 101. In addition, the lower surface of the beam splitter 101 can also similarly be used as a reference surface for the slider mechanism.

Moreover, in the example shown in FIG. 11, the slider mechanism is composed of two pairs of the rails and the sliders and the feed mechanism. However, the slider mechanism may be composed of only a rail and a slider, or may be composed of only a feed mechanism.

Moreover, when the second lens barrel 120 is not in contact with the second light-exit surface 105 of the beam splitter 101 as in the configuration shown in FIG. 11, a portion other than the second lens barrel 120, such as a portion of the second imaging device holding member 123, may be slid in contact with a surface of the beam splitter 101.

Moreover, the slider mechanism does not have to include the rail and the slider engaged with the rail, and various components such as a combination of a groove and a member engaged with the groove can be used as long as they allow shifting along the longer side of the incident surface of the beam splitter 101 and prevent shifting along a line orthogonal to the longer side of the incident surface.

Moreover, in each embodiment described above, it is configured such that the second imaging device is horizontally movable. However, it may be configured such that the first imaging device is horizontally movable. Further, it can be configured such that both the first imaging device and the second imaging device are horizontally movable, and the present invention is also similarly applicable to such a case.

The present invention is useable as a stereo 3D imaging apparatus which takes an three-dimensional image, and is useful particularly for a camera and a video camera which require precise optical axis adjustment.

While the invention has been described in detail, the foregoing description is in all aspects illustrative and not restrictive. It will be understood that numerous other modifications and variations can be devised without departing from the scope of the invention.

What is claimed is:

1. A stereo-image photographing apparatus comprising:
a beam splitter having an incident surface of rectangular form and on which imaging light from a photographic subject is incident, an optically functional surface reflecting first imaging light, being a portion of imaging light incident on the incident surface, in a direction paralleling the shorter side of the rectangular form and passing second imaging light being the remaining portion of the imaging light, a first light-exit surface through which the first imaging light exits, and a second light-exit surface through which the second imaging light exits;
a first lens barrel directly facing the first light-exit surface and through which the first imaging light exiting the first light-exit surface constructs an image;
a second lens barrel directly facing the second light-exit surface and through which the second imaging light exiting the second light-exit surface constructs an image;
a first imaging device mounted on the first lens barrel, for generating a first image on the basis of the first imaging light constructing an image through the first lens barrel; and
a second imaging device mounted on the second lens barrel, for generating a second image on the basis of the second imaging light constructing an image through the second lens barrel.

2. The stereo-image photographing apparatus according to claim 1, further comprising:
a first lens-barrel holding member placing an end of the first lens barrel into abutment with the first light-exit surface such that the optical axis of the first lens barrel is retained perpendicular to the first light-exit surface; and
a second lens-barrel holding member placing an end of the second lens barrel into abutment with the second light-exit surface such that the optical axis of the second lens barrel is retained perpendicular to the second light-exit surface.

3. The stereo-image photographing apparatus according to claim 2, wherein:
the first lens barrel is a lens barrel to and from which the first lens barrel holding member is attachable and detachable; and
the second lens barrel is a lens barrel to and from which the second lens barrel holding member is attachable and detachable.

4. The stereo-image photographing apparatus according to claim 2, further comprising:
a beam-splitter holding member retaining the beam splitter;
a first imaging-device holding member retaining the first imaging device;
a second imaging-device holding member retaining the second imaging device; and
a base member retaining the beam-splitter holding member, the first imaging-device holding member, and the second imaging-device holding member; wherein
the first imaging-device holding member maintains a positional relationship, determined by the first lens-barrel holding member, between the first lens barrel and the beam splitter, and
the second imaging-device holding member maintains a positional relationship, determined by the second lens-barrel holding member, between the second lens barrel and the beam splitter.

5. The stereo-image photographing apparatus according to claim 4, wherein the beam splitter holding member and the base member are integrally formed.

6. The stereo-image photographing apparatus according to claim 2, further comprising a beam splitter holding member retaining the beam splitter; wherein
the first lens-barrel holding member and the second lens-barrel holding member are attached to the beam splitter holding member,
the first imaging device is held by the first lens-barrel holding member, and
the second imaging device is held by the second lens-barrel holding member.

7. The stereo-image photographing apparatus according to claim 2, further comprising at least one of either a slider mounted on the first light-exit surface of the beam splitter to enable the first lens-barrel holding member to parallel-shift along the longer side of the rectangular form, or a slider mounted on the second light-exit surface of the beam splitter to enable the second lens-barrel holding member to parallel-shift along the longer side of the rectangular form.

8. The stereo-image photographing apparatus according to claim 1, further comprising a slider rectilinearly shiftably guiding the second lens barrel and the second imaging device along the longer side of the rectangular form, and restricting the second lens barrel and the second imaging device against shifting along a line orthogonal to the longer side.

9. The stereo-image photographing apparatus according to claim 8, wherein the slider is provided on the second light-exit surface of the beam splitter to guide the second lens barrel paralleling the second light-exit surface along the longer side of the rectangular form.

10. The stereo-image photographing apparatus according to claim 8, further comprising a second imaging-device holding member retaining the second imaging device, wherein
the slider is mounted on the second imaging-device holding member to guide the second imaging device and the second lens barrel along the longer side of the rectangular form.
